(19) United States
(12) Patent Application Publication
(10) Pub. No.: US 2020/0157391 A1
(43) Pub. Date: May 21, 2020

(54) TIRE PROVIDED WITH AN OBJECT ATTACHED TO THE SURFACE THEREOF

(71) Applicant: COMPAGNIE GENERALE DES ETABLISSEMENTS MICHELIN, Clermont-Ferrand (FR)

(72) Inventors: XAVIER LEBRUN, Clermont-Ferrand (FR); GUILLAUME PIBRE, Clermont-Ferrand (FR)

(21) Appl. No.: 16/626,670

(22) PCT Filed: Jun. 11, 2018
(86) PCT No.: PCT/FR2018/051355

§ 371 Date: Dec. 26, 2019

(30) Foreign Application Priority Data
Jun. 27, 2017 (FR) 1755853

(51) Int. Cl. C09J 143/04; B29D 30/00; B29D 30/06; B60C 23/04; C09J 7/38; B01J 23/42

(52) U.S. Cl. CPC C09J 143/04; B29D 30/0061; B29D 30/06; C08K 5/14; C09J 7/38; B01J 23/42; B29D 2030/0077; B60C 23/0493

(57) ABSTRACT

A tire is equipped with an object attached to said tire, said tire including, at the interface between the tire and the attached object, an adhesive layer with a thickness in a range from 1 to 5 mm, characterized in that said adhesive layer is based on a pressure-sensitive silicone adhesive. A process for attaching an object to a tire comprises the steps of applying to the object and/or to the tire an adhesive layer comprising a pressure-sensitive silicone adhesive, said adhesive layer having a thickness in a range extending from 1 to 5 mm; and of joining together the object and the tire.

The present invention relates to tyres, and more particularly to tyres equipped with an object, for example an electronic object, attached to the inner and/or outer surface thereof.

The recent development of systems for monitoring the pressure of tyres of a rolling vehicle (“Tyre Pressure Monitoring Systems” or “TPMS”) is limited by the difficulty of rapidly and durably attaching an object to the surface of a tyre.

US 2011/0308706 proposes a tyre including a silicone soundproofing foam, attached via a self-adhesive rubber composition to a tyre surface prepared so as to be free of non-stick product.

Also, US 2007/0089824 proposes the attachment of a sound deadener via the use of adhesive strips on a tyre surface prepared so as to be free of non-stick product. This solution requires the handling of these adhesive strips. The adhesive strips described are very flexible and very thin objects. This entails fragility of these materials, which can be damaged by elongation or tearing during their handling during the manufacture of the tyre. In order to limit this mechanical damage and to obtain the optimum properties associated with the use of the adhesive strips, they must be supported on a non-stick strip, which gives rise to the production of waste. Furthermore, the use of adhesive strips may lead to limited adhesion of the objects attached in the tyres, entailing reduced working flexibility as regards the nature of the objects to be attached.

In view of the applications undergoing development which are based on the attachment of objects, notably electronic objects, onto tyres, it is advantageous for manufacturers to develop attachment solutions that are quick, efficient and long-lasting, while at the same time making efforts not to modify the manufacture of the tyres that are liable to receive these attached objects. In particular, it is advantageous to meet these conditions without necessitating the elimination of the non-stick products on the surface of tyres, without necessitating the preparation of a specific area of the tyre for receiving the object to be attached, so as to be able to attach the object to any type of tyre, without preparation of the surface of this tyre. It is also advantageous to have attachment solutions that allow flexibility as regards the nature of the object to be attached.

The subject of the invention is a tyre equipped with an object attached to said tyre, said tyre including, at the interface between the tyre and the attached object, an adhesive layer with a thickness in a range extending from 1 to 5 mm, characterized in that said adhesive layer is based on a pressure-sensitive silicone adhesive.

The use of such an assembly has the advantage of enabling quick, efficient and long-lasting attachment of the object to any type of tyre, without necessitating preparation of the surface of the tyre before attaching the object.

Also, the specific materials used for the invention make it possible to conserve good adhesion of the object to the tyre, including at elevated temperature during the use of the tyre.

Moreover, this method of attachment affords a high degree of freedom as regards the geometry and functions of the object, due to the attachment of the object after curing (vulcanization) of the tyre.

The object may be a casing that can receive an electronic device. The object may also be an electronic device. It may also be a marking on the tyre or a decoration.

Another subject of the invention is a process for attaching an object to a tyre, comprising the steps of applying to the object and/or to the tyre an adhesive layer comprising a pressure-sensitive silicone adhesive, said adhesive layer having a thickness in a range extending from 1 to 5 mm; and of joining together the object and the tyre.

The attachment of the object is thus achieved very quickly and very simply. The attachment is effective and long-lasting. It also has the advantage of being reversible and of not necessitating the preparation of a surface for receiving the object on the tyre, such as a particular area intended for the attachment during the manufacture of the tyre, or the elimination of the non-stick products on the tyre.

### DETAILED DESCRIPTION OF THE INVENTION

In the present description, unless expressly indicated otherwise, all the percentages (%) shown are mass percentages.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The details of the invention will be explained below by the description, firstly, of the specific constituents of the tyre according to one of the subjects of the invention, and then by the description of the method of manufacture of the tyre and the characterization tests performed.

Tyre of the Invention

The tyre according to the invention is equipped with an object attached to said tyre, said tyre including, at the interface between the tyre and the attached object, an adhesive layer with a thickness in a range from 1 to 5 mm, characterized in that said adhesive layer is based on a pressure-sensitive silicone adhesive.

### Adhesive Layer

### Composition of the Adhesive Layer

The adhesive layer of the tyre of the invention is based on a pressure-sensitive silicone adhesive.

As is known to a person skilled in the art of adhesives, the term “pressure-sensitive adhesive” (PSA) is used to denote materials that are intrinsically tacky or that have been rendered tacky by the addition of tackifying resins. Several methods make it possible to identify a PSA, notably the following three:
a PSA may be described by the Dahlquist criteria from the mechanical and viscoelastic viewpoint,
a PSA is a material which has permanent and aggressive tack at room temperature and adheres strongly to various surfaces by simple contact without the need for pressure greater than manual pressure,
a PSA is a material whose storage modulus is between 0.02 MPa and 0.04 MPa at a frequency of 0.1 rad/s (0.017 Hz) and 0.2 MPa to 0.8 MPa at a frequency of 100 rad/s (17 Hz).

The most widely known and used adhesive strips, occasionally referred to as “scotch” or “tape”, are adhesive strips based on “acrylic” PSA, known to those skilled in the art (“Technology of Pressure Sensitive Adhesives and Products” by I. Benedek and M. F. Feldstein, chapter 5, “Acrylic adhesives” by P. B. Foreman) comprising 50% to 100% by mass of “primer” monomers.

Acrylic PSA adhesive strips known by the term “VHB” (very high bond) are proposed by the company 3M, can conform to non-flat surfaces and can be used for the purposes of the invention, for instance “VHB4955”. “VHB” high-performance adhesive strips are assembly strips constituted of a homogeneous mass of acrylic foam adhesive.

Unlike acrylic PSAs, the pressure-sensitive silicone adhesives of silicone PSA type are highly resistant to ageing, including under the severe conditions of use in tyres. These properties of silicone PSAs are inherent to the nature of silicones, including their flexibility over a wide temperature range, the low intermolecular interactions, their low surface tension, their heat stability, the UV transparency, the stability at high temperature, excellent electrical insulation properties, their chemical resistance and the weather resistance.

Pressure-sensitive silicone adhesives may notably be of two types, corresponding to two production processes, by polycondensation or by polyaddition.

Pressure-sensitive silicone adhesives of polycondensation type are based on a silicone polymer, a siloxane resin and a solvent. These silicone PSAs of polycondensation type are usually delivered in a solvent.

The silicone polymer is preferably a high molecular weight polymer, with a mass-average molecular mass (Mw) in a range extending from 600 000 to 1 000 000 g/mol. Preferably, the polymer has at least one silanol (SiOH) end group.

Dimethylsiloxane and diphenylsiloxane copolymers may be found in commercial silicone PSAs. Silicones containing diphenylsiloxane units offer improved adhesive properties, in particular at elevated temperatures. However, the presence of diphenylsiloxane also brings about an increase in the glass transition temperature, increasing the stiffness of the silicone polymer backbone. Consequently, the amount of diphenylsiloxane in a silicone polymer is preferably less than or equal to 20%, more preferentially in a range extending from 0 to 18%, more preferentially from 5% to 15%.

The siloxane resin is the other major component of pressure-sensitive silicone adhesives of polycondensation type. Preferably, for the invention, in the pressure-sensitive silicone adhesives of polycondensation type, the siloxane resin has a number-average molecular mass (Mn) in a range extending from 1000 to 10 000 g/mol.

The siloxane resin includes a wide range of siloxane materials, of M (monofunctional), D (difunctional), T (trifunctional) or Q (quadrifunctional) type. The resins most commonly used for the manufacture of silicone PSA are “MQ” resins, predominantly constituted of M (monofunctional) units and Q (quadrifunctional) units; although many other combinations (MDT, MTQ, DTQ and MDTQ) may also be used. MQ resins are preferentially used for the invention, in the pressure-sensitive silicone adhesives of polycondensation type. This resin is commonly represented in the form [MₓQ]m where x is the M/Q ratio, and is typically between 0.6 and 1.2 to 1 and m corresponds to the number-average molecular mass (Mn) of the resin, between 1000 and 10 000 g/mol.

MQ resins may be synthesized from sodium silicate and chlorosilanes via a relatively complex process, and delivered in a solvent, such as toluene or xylene. The M:Q ratio and the silanol content are carefully controlled during the manufacturing process to give the resins the desired structure. The characterization of an MQ resin structure is an arduous task, and as such the variants are usually expressed in terms of viscosity of the solution in toluene or xylene. For its part, the pure MQ resin, free of solvent, is a brittle solid with a glass transition temperature of between 270 and 350° C.

The use of pressure-sensitive silicone adhesives of polycondensation type involves the presence of a solvent in the composition, before said solvent is evaporated off. The resulting adhesive layer thus no longer comprises solvent, or simply comprises a trace amount thereof, this solvent being an ingredient in the manufacture of the composition and a means for laying the composition on a support during its use as an adhesive layer.

Preferably, the solvent is an aromatic solvent, preferably chosen from the group constituted by xylene, toluene or a mixture thereof. More preferentially, the solvent is toluene. Preferably, the silicone PSAs of polycondensation type comprise 50% or 60% of solids/dry residue in the solvent to keep the viscosity of the product within a suitable range, preferably below 80 000 mPa/s for its use.

Pressure-sensitive silicone adhesives of polyaddition type are based on a silicone polymer and a catalyst. One advantage of this type of composition is that no solvent is required in the composition.

In pressure-sensitive silicone adhesives of polyaddition type, the silicone polymers preferably bear vinyl-silicon (Si-Vi) functional groups and silicon hydride (SiH) groups.

The catalyst is preferentially a platinum catalyst, and preferably platinum (Pt). The platinum-catalysed crosslinking reaction of the functional silicone polymer allows the reaction of silicon hydride (SiH) with the vinyl function to form a network via methylene bonds.

The composition of the adhesive layer may optionally include various additives, such as fillers, peroxides, pigments, etc.

According to a preferential embodiment of the invention, the composition of the adhesive layer comprises at least one peroxide. Peroxides, in particular 2,4-dichlorobenzoyl peroxide and dibenzoyl peroxide, are preferred. Peroxides make it possible to achieve crosslinking in the adhesive composition and are incorporated in solution form. The peroxide crosslinking operation is usually performed in multizone ovens, with a temperature of the first zone of the order of 70 to 90° C., so that the solvent can be evaporated off before the decomposition of the peroxide takes place.

The peroxide crosslinking of silicone PSAs is a multi-step mechanism, which is well known to those skilled in the art. At elevated temperature, the peroxide is first decomposed into radicals. These radicals formed lead to the formation of methylene radicals in the silicone backbone. The methylene radicals react with adjacent radicals to form bridges between the methylenes of the silicone polymer. Temperatures of 130 to 170° C. or more for 2,4-dichlorobenzoyl peroxide and of 150 to 200° C. for benzoyl peroxide are typical. The peroxide concentration is typically from 0.5% to 3% by mass of adhesive composition.

Preferentially also, the composition of the adhesive layer includes a filler. The filler may be silicone or carbon black or any other reinforcing or non-reinforcing filler. It may make it possible to improve the cohesion of the product by not degrading or degrading very little the adhesion properties of the product. The filler may also be used to reduce the cost of the bonding system by adding an inexpensive compound (in particular in the case of non-reinforcing fillers).

Many pressure-sensitive silicone adhesives are commercially available. Alternatively, the preparation of the adhesive layer of the tyre of the invention may take place by mixing the various ingredients detailed hereinabove, via any means known to a person skilled in the art, in the presence of solvent, for example, and particularly in the case of a pressure-sensitive silicone adhesive of polycondensation type, or any other means.

### Thickness of the Adhesive Layer

The adhesive layer of the tyre of the invention has a thickness in a range extending from 1 to 5 mm.

The known adhesive strips such as the acrylic PSA adhesive strips known under the name “VHB”, or alternatively (see EDT silicone tape) have very low thicknesses and are often preferred with the lowest possible thicknesses. Typically, these thicknesses are of the order of a few tenths of a millimetre and notably less than 0.38 mm as indicated in US2007/0089824. Thus, it is noted that the thickness of the adhesive layer of the invention differs from the known adhesive strips, with a thickness greater than a millimetre; which allows the adhesion of objects of diverse and varied nature for, on the one hand, the surface of the tyre and, on the other hand, that of the object to be attached.

When the thickness of the adhesive layer is too low, the mechanical uncoupling is insufficient and the adhesion of the object to the tyre is less satisfactory. When the thickness is too high, the adhesion may be reduced due to decohesion of the adhesive layer. Moreover, the evaporation of the solvent is more difficult, making the adhesion slower. For these reasons, preferentially, the adhesive layer has a thickness in a range extending from 1 to 3 mm.

A person skilled in the art knows how to adapt the thickness of the adhesive layer as a function notably of the object to be attached and/or of the area of the tyre onto which the object is attached.

The adhesive layer in the tyre of the invention is obtained via any means known to those skilled in the art and, for example and preferentially, according to the process of the invention described hereinbelow.

Tyre onto which the Object is Attached

The invention relates to any type of pneumatic tyre, and more particularly tyres intended to equip motor vehicles of the passenger vehicle, SUV (“Sports Utility Vehicles”), two-wheel vehicle (notably motorcycle) or aircraft type, and industrial vehicles chosen from vans, heavy-duty vehicles, that is to say underground trains, buses, heavy road transport vehicles (lorries, tractors, trailers) or off-road vehicles, such as heavy agricultural or construction plant vehicles, and other transportation or handling vehicles.

The tyre to which the object is attached may be prepared via any means known to those skilled in the art, with the usual materials. Preferably, it is cured before attaching the object as discussed hereinbelow for the process of the invention.

The tyre of the invention is equipped with the object attached to any inner and/or outer surface, and notably the sidewall or the leaktight inner layer (sometimes known as the inner rubber or “inner liner”). It is thus said that an object is attached “to” the tyre, which means equally to an outer or inner surface (“to” or “in” the tyre).

In a manner known to those skilled in the art, the surface of the tyre and in particular the surface of the inner wall, usually the inner liner, may be equipped with a layer of mould-release agent, sometimes also known as non-stick product or whitewash. This layer is usually deposited on the surface of the tyre before it is cured in order to prevent this surface from adhering strongly to the membrane of the curing press or to the curing mould during curing. This layer of mould-release agent acts as a non-stick protective layer.

One advantage of the invention is that the adhesive layer allows the adhesion of the object, including when the tyre is equipped with a layer of mould-release agent.

Thus, according to a preferred embodiment of the invention, the tyre in accordance with the invention and which is useful for the process of the invention comprises at least one layer of mould-release agent.

Mould-release agents are well known to those skilled in the art and may notably and preferentially comprise at least one silicone polymer and talc. Preferentially, the layer of mould-release agent is constituted of a silicone polymer or of a mixture of silicone polymers and of talc.

The layer of mould-release agent may be obtained, for example, by spraying an aqueous suspension of one or more silicone polymers and of talc over a non-crosslinked surface of the tyre.

### Object Attached to the Tyre

The object may be of any type. It may be, for example, a casing that can receive an electronic device (for example an RFID chip). The object may also be an electronic device (for example an RFID chip). It may also be a marking on the tyre or a decoration. It may also be a layer having a particular function, such as a soundproofing foam or a self-sealing layer.

Preferably, the object is chosen from the group constituted by an electronic device, a casing that can receive an electronic device, a decoration, a marking, a soundproofing device (such as a soundproofing foam), a self-sealing device (such as a self-sealing layer).

II. Process of the Invention

The process according to the invention is a process for attaching an object to a tyre, comprising the following steps:

application to the object and/or to the tyre of an adhesive layer comprising a pressure-sensitive silicone adhesive, said adhesive layer having a thickness in a range extending from 1 to 5 mm;

joining together the object and the tyre.

According to this process, and as explained previously, the term “to the tyre” should be understood equally as meaning to an outer surface of the tyre and to an inner surface of the tyre, i.e. “in” the tyre.

The attachment of the object is thus achieved very quickly and very simply. The attachment is effective and long-lasting. It also has the advantage of being reversible.

### Application of the Adhesive Layer

The adhesive layer may be applied via any means known to those skilled in the art, such as deposition as a thin film in the presence of the solvent onto the tyre and/or the object to be attached. Another way is to prepare a bonding film with composition in order to perform the joining together between the two parts to be bonded with this adhesive.

The adhesive layer may be applied either to the tyre, to the area chosen for the attachment of the object; or to the object to be attached, or else both to the tyre and to the object to be attached. Preferably, to limit the industrial intrusion, the adhesive layer is deposited onto the object to be attached.

Preferably, when the adhesive layer is based on a pressure-sensitive silicone adhesive of polycondensation type, this layer is applied via any means known to those skilled in the art, such as deposition of a film of controlled thickness, and the solvent is then evaporated off. This evaporation may be performed by any means known to those skilled in the art, preferably by evaporation in ambient air, at room temperature (23° C.), for example for 24 hours, for a film thickness of 3 mm.

Joining together of the Object and the Tyre

For the process of the invention, it is possible to join together the object and the tyre by any means known to those skilled in the art. Preferably, the joining together is performed by manual pressure, not necessitating the use of any tool.

The joining pressure is preferably greater than 0.05 bar above atmospheric pressure.

### Implementation Examples

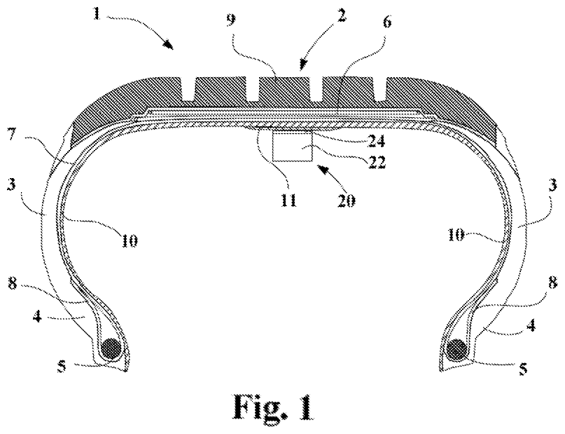

Additional elements of the invention are now described with the aid of FIG. 1, presented in a non-limiting manner, which shows a tyre in accordance with the invention, with an object attached to its surface.

This tyre 1 includes a crown 2 reinforced by a crown reinforcement or belt 6, two sidewalls 3 and two beads 4, each of these beads 4 being reinforced with a bead wire 5. The crown reinforcement 6 is surmounted radially externally by a rubber tread 9. A carcass reinforcement 7 is wound around the two bead wires 5 in each bead 4, the turn-up 8 of this reinforcement 7 being, for example, arranged towards the outside of the tyre 1. The carcass reinforcement 7 is, in a manner known per se, formed of at least one ply reinforced with “radial” cords, for example made of textile or metal, that is to say that these cords are positioned virtually parallel to each other and extend from one bead to the other so as to form an angle of between 80° and 90° with the median circumferential plane (plane perpendicular to the axis of rotation of the tyre which is located midway between the two beads 4 and passes through the middle of the crown reinforcement 6). A leaktight layer 10 extends from one bead to the other radially on the inside with respect to the carcass reinforcement 7.

The tyre 1 is such that its inner wall includes an object 20 attached via an adhesive layer 11. The adhesive layer 11 is constituted of a pressure-sensitive silicone adhesive, as described previously and notably chosen from those proposed in the examples below.

In the embodiment of the invention presented in FIG. 1, the attached object 20 includes a casing 22 and an adhesive layer 24. The material of the adhesive layer 24 is of the same nature as that of the adhesive layer 11. The total thickness of the adhesive layers 11 and 24 is preferably between 1 and 5 mm, and very preferentially between 1.5 and 3 mm.

The attachment of the object 20 to the surface of the tyre 1 is performed according to the process of the invention, comprising the following steps:

application to the object and/or to the tyre of an adhesive layer based on a pressure-sensitive silicone adhesive, having a thickness of 2 mm, for example;

joining together the object and the tyre.

In the examples discussed hereinabove, the object is attached to the inner surface of the tyre; it is also possible to place it on an outer surface of the tyre, for example on the tyre sidewall.

### Tests

### Manual Peel Test

Adhesion tests (peel tests) were performed to test the capacity of the adhesive layer to adhere to a diene elastomer layer, more precisely to a customary rubber composition for a leaktight tyre inner layer (sometimes also known as the “inner rubber” or “inner liner”) based on butyl rubber (copolymer of isobutylene and isoprene), also including the customary additives (filler, sulfur, accelerator, ZnO, stearic acid, antioxidant). Needless to say, this test may be adapted to the case where the object must be placed on the tyre sidewall; in this case, to produce the test specimens, a layer of rubber sidewall mixture will be used instead of a layer of customary inner liner.

The peeling test specimens (for 180° -type peeling) were prepared by stacking the following products:

a fabric of passenger vehicle carcass ply type;

a layer of customary inner liner (1 mm); the assembly of this leaktight layer and of the adjacent carcass ply fabric being prebaked for 40 minutes at 150° C., and, according to the cases outlined in the examples, a layer of non-stick product may be added to the surface of the inner layer which will be in contact with the adhesive layer;

an adhesive layer to be tested;

a layer of customary inner liner (1 mm); and

a fabric of passenger vehicle carcass type, the assembly of this carcass ply fabric and of the adjacent leaktight layer being prebaked for 40 minutes at 150° C., and, according to the cases outlined in the examples, a layer of non-stick product may be added to the surface of the inner layer which will be in contact with the adhesive layer.

An incipient failure is placed at the interface between one of the layers of inner liner and the adhesive layer.

Strips with a width of 30 mm were cut out using a cutting machine. The two sides of the incipient failure were subsequently placed in the jaws of an Instron° brand tensile testing machine. The tests are performed at room temperature and at a pull rate of 100 mm/min. The tensile stresses are recorded and the latter are standardized by the width of the test specimen. A curve of force per unit width (in N/mm) as a function of the movable crosshead displacement of the tensile testing machine (between 0 and 200 mm) is obtained. The adhesion value retained corresponds to the mean value of this curve.

The peel measurements are performed at room temperature (23° C.) and/or at 80° C., depending on the case.

### Composition Examples:

Table 1 below presents the compositions tested, in which:

C-1 is a customary composition of a cured leaktight inner liner free of non-stick product;

C-2 is a customary composition of a cured leaktight inner liner covered with non-stick product. The non-stick product is constituted of water, a silicone polymer and talc;

C-3 is an acrylic adhesive strip Acrotape AFT7410 sold by the company 3M;

C-4 is a toluene solution;

C-5 and C-6 are pressure-sensitive silicone adhesives suitable for the adhesive layer of the tyre according to the invention;

C-7 is a pressure-sensitive silicone adhesive suitable for the adhesive layer of the tyre according to the invention.

TABLE 1
compositions in phr

| Composition | C-1 | C-2* | C-3 | C-4 | C-5 | C-6 | C-7 |
|---|---|---|---|---|---|---|---|
| Butyl elastomer (1) | 100 | 100 | | | | | |
| Carbon black (N772) | 50 | 50 | | | | | |
| Zinc oxide | 1.5 | 1.5 | | | | | |
| Stearic acid | 1.5 | 1.5 | | | | | |
| Sulfenamide (2) | 1.2 | 1.2 | | | | | |
| Sulfur | 1.5 | 1.5 | | | | | |
| PSA (3) | | | 100 | | | | |
| Toluene | | | | 100 | | | |
| PSA (4) | | | | | 100 | 100 | |
| Peroxide (5) | | | | | | 3 | |
| PSA (6) | | | | | | | 100 |

*Composition C2 is covered with non-stick product before curing, followed by application of an adhesive layer
(1) Bromo copolymer of isobutylene and isoprene, Bromobutyl 2222, sold by the company Exxon Chemical Co;
(2) N-Dicyclohexyl-2-benzothiazolesulfenamide (Santocure CBS from the company Flexsys);
(3) Acrylic PSA Acrotape AFT7410 from the company 3M-thickness 3 mm.
(4) Silicone PSA Silicolease PSA 418 from the company Bluestar silicone-obtained via a solution comprising 60% PSA and 40% toluene, followed by evaporation of the toluene-final thickness 3 mm.
(5) Peroxide Luperox 101 sold by the company Sigma Aldrich
(6) Silicone PSA Gergosil 902 D, silicone of composition similar to the silicone Silicolease PSA 418, layer 100 μm thick on PET support 23 μm thick

### Test Results

To represent the adhesion of the adhesive layer on the leaktight inner liner of the tyre, in the absence of non-stick product, the adhesion values are measured (peel test) for the assemblies of the layers C-3 to C-7 on the layer C-1 and the results are presented in Table 2.

TABLE 2

| | C-3/ | C-4/ | C-5/ | C-6/ | C-7/ |
|---|---|---|---|---|---|
| | C-1 | C-1 | C-1 | C-1 | C-1 |
| Adhesion values | 0.20 | 0.13 | 2.3 | 3.5 | 0.4 |
| (N/mm) at 23° C. | | | | | |
| Adhesion values | nm* | nm* | 1.4 | 2 | 0.2 |
| (N/mm) at 80° C. | | | | | |

*nm: not measured

The results presented in table 2 show the value of using a pressure-sensitive silicone adhesive according to the invention as adhesive layer. This allows adhesion values of the adhesive layer on the inner rubber greater than those proposed by an acrylic adhesive strip or the toluene solvent. The test with toluene alone makes it possible to show that it is not the solvent which promotes the adhesion with the adhesive layer of the invention, despite the fact that said solvent is present during the application of the adhesive layer in solution. The thickness of the layer C-7 is insufficient to create adhesion that is as good as with the layers in accordance with the invention.

To represent the adhesion of the adhesive layer on the leaktight inner liner of the tyre, in the presence of non-stick product, the adhesion values are measured (peel test) for the assemblies of the layers C-3 to C-5 on the layer C-2 and the results are presented in Table 3.

TABLE 3

| | C-3/C-2 | C-4/C-2 | C-5/C-2 |
|---|---|---|---|
| Adhesion values (N/mm) at | 0.1 | 0 | 2 |
| 23° C. | | | |
| Adhesion values (N/mm) at | nm* | nm* | 1.1 |
| 80° C. | | | |

*nm: not measured

The results presented in table 3 show the value of using a pressure-sensitive silicone adhesive according to the invention as adhesive layer. This allows adhesion values of the adhesive layer on the inner rubber greater than those proposed by an acrylic adhesive strip or the toluene solvent. The test with toluene alone makes it possible to show that it is not the solvent which promotes the adhesion with the adhesive layer of the invention, despite the fact that said solvent is present during the application of the adhesive layer in solution.

The invention thus enables rapid and reversible attachment of objects to the surface of a tyre without the drawbacks associated with the preparation of the contact surface.

Finally, this method of attachment affords a high degree of freedom as regards the geometry and functions of the object, due to the attachment post-vulcanization.

A comparative rolling test is performed between the thin silicone layer C-7 and the silicone layer C-5. To do this, a sensor is attached using an adhesive layer C-7 or C-5 to the inner liner of a tyre.

The rolling test is performed on a roller, at a constant speed of 110 km/h, with overloading and over-inflation of the tyre in order to place maximum stress on the crown. The tyre is trimmed to further increase the stress. The temperature of the inner liner stabilizes at about 85° C. during rolling.

The performance of the adhesion solution is determined by defining three stages and examining the stage during which the sensor becomes detached:
Stage 1: the tyre rolls for at least 5000 km
Stage 2: the tyre rolls for at least 10 000 km
Stage 3: death of the tyre (15 000 km)

The results are presented in Table 4.

TABLE 4

| | Results |
|---|---|
| | (stage during which the |
| Test product | sensor becomes detached) |
| C-7 on inner liner | 1 |
| C-7 on inner liner with | No possibility of bonding (no rolling) |
| non-stick product | |
| C-5 on inner liner | 3 (death of the tyre, sensor still bonded) |
| C-5 on inner liner with | 3 (death of the tyre, sensor still bonded) |
| non-stick product | |

It is seen that, in the tyre according to the invention, the sensor remains bonded up to the point at which the tyre is completely worn.

1.-25. (canceled)

26. A tire equipped with an object attached to the tire, the tire including, at the interface between the tire and the attached object, an adhesive layer with a thickness in a range from 1 to 5 mm,
wherein the adhesive layer is based on a pressure-sensitive silicone adhesive.

27. The tire according to claim 26, wherein the pressure-sensitive silicone adhesive is of polycondensation or polyaddition type.

28. The tire according to claim 27, wherein the pressure-sensitive silicone adhesive is of polycondensation type and is based on a silicone polymer, a siloxane resin and a solvent.

29. The tire according to claim 28, wherein the silicone polymer has a weight-average molecular mass Mw in a range extending from 600,000 to 1,000,000 g/mol.

30. The tire according to claim 28, wherein the silicone polymer bears at least one silanol end group.

31. The tire according to claim 28, wherein the pressure-sensitive silicone adhesive of polycondensation type comprises less than 20% by mass of diphenylsiloxane.

32. The tire according to claim 28, wherein the siloxane resin has a number-average molecular mass of from 1000 to 10,000 g/mol.

33. The tire according to claim 28, wherein the solvent is an aromatic solvent.

34. The tire according to claim 26, wherein the pressure-sensitive silicone adhesive is of polyaddition type and is based on a silicone polymer and a catalyst.

35. The tire according to claim 34, wherein the silicone polymer bears vinyl-silicon and silicon hydride functional groups.

36. The tire according to claim 34, wherein the catalyst is a platinum catalyst.

37. The tire according to claim 26, wherein the pressure-sensitive silicone adhesive further comprises a peroxide.

38. The tire according to claim 26, wherein the pressure-sensitive silicone adhesive further comprises a filler.

39. The tire according to claim 26, wherein the thickness of the adhesive layer is in a range extending from 1 to 3 mm.

40. The tire according to claim 26, wherein the object is selected from the group consisting of an electronic device, a casing that can receive an electronic device, a decoration, a marking, a soundproofing device, and a self-sealing device.

41. The tire according to claim 26, wherein the object is an electronic device or a casing that can receive an electronic device.

42. The tire according to claim 26, wherein the object is attached to an inner surface of the tire.

43. The tire according to claim 26, wherein the object is attached to an outer surface of the tire.

44. The tire according to claim 26, wherein a surface of the tire to which the object is attached comprises a layer of mold-release agent.

45. A process for attaching an object to a tire comprising the following steps:
applying, to the object or to the tire or to both the object and the tire, an adhesive layer comprising a pressure-sensitive silicone adhesive, the adhesive layer having a thickness in a range extending from 1 to 5 mm; and
joining together the object and the tire.

46. The process according to claim 45, wherein the adhesive layer comprises a pressure-sensitive silicone adhesive of polycondensation type, and the method further comprises the step of:
evaporating a solvent from the adhesive layer.

47. The process according to claim 46, wherein the evaporating step is performed in ambient air and at room temperature.

48. The process according to claim 45, wherein the joining step is performed by manual pressure.

49. The process according to claim 45, wherein the object is attached to a cured tire.

50. The process according to claim 49, wherein the object is attached to the tire without a step of eliminating a layer of mold-release agent on a surface of the tire.
